(19) United States
(12) Patent Application Publication
(10) Pub. No.: US 2023/0325773 A1
(43) Pub. Date: Oct. 12, 2023

(54) MULTI-USER COMPLEX PROBLEMS RESOLUTION SYSTEM

(71) Applicant: LUXEMBOURG INSTITUTE OF SCIENCE AND TECHNOLOGY (LIST), ESCH-SUR-ALZETTE (LU)

(72) Inventor: Dimitra ANASTASIOU, ESCH-SUR-ALZETTE (LU)

(21) Appl. No.: 17/909,571

(22) PCT Filed: Mar. 2, 2021
(86) PCT No.: PCT/EP2021/055182

§ 371 Date: Sep. 6, 2022

(30) Foreign Application Priority Data
Mar. 3, 2020 (LU) LU101660

(51) Int. Cl. G06Q 10/101

(52) U.S. Cl. CPC G06Q 10/101

(57) ABSTRACT

A multi-user complex problems resolution system, in various instances an urban design complex problem resolution system, comprising a plurality of interconnected user devices, each device embedding a model data structure comprising a representation of a physical system, the system being provided with at least one module connected to the devices, the module carrying out the steps of receiving data and metadata modifying variables, from all the devices; detecting an input pattern based on the data and metadata received from all the devices; dynamically generating a customized data structure based on the input pattern; updating the model data structure of the devices with the customized data structure. Also, a corresponding computer-implemented method.

### CROSS-REFERENCE TO RELATED APPLICATIONS

The present invention is the US national stage under 35 U.S.C. §371 of International Application No. PCT/EP2021/055182 which was filed on Mar. 2, 2021, and which claims the priority of application LU101660 filed on Mar. 3, 2020 the contents of which (text, drawings and claims) are incorporated here by reference in its entirety.

### FIELD

The invention is directed to the field of systems and methods for forming and solving complex problems in a collaborative manner, and in particular in the context of multiple users using multiple interconnected devices.

### BACKGROUND

The granted patent EP 2 883 174 B1 discloses a computer design system used to develop a customized application for modelling physical systems in an engineering analysis system. Based on a series of physical templates and a series of application templates, the system develops a customized data structure which is then frozen and used to solve a particular problem by a single user.

The paper “Design of collaboration-support tools for group problem solving” (Fidas et al., January 2001) discusses a software where two users can alternatively act on an object.

The systems of these documents are however not adapted to a multi-user context, where multiple users attempt to solve together a complex problem. The complexity of the problem may be inherent to the fact that several trade-off solutions may exist and that different users may have different interests towards different solutions. The prior art does only “select” an application for a particular use but is not versatile enough for helping the resolution of a more complex problem with the technical difficulties inherent to a multiple-user dimension.

### SUMMARY

The present invention provides a system which enables multiple users to solve a complex problem related to a physical system, in a more efficient way, and with computing devices that require less memory capacity or computing power.

The invention is directed to a multi-user complex problems resolution system, in various instances an urban design complex problem resolution system, comprising a plurality of interconnected user devices, each device embedding a model data structure comprising a representation of a physical system, each device being configured to receive input from one or more users in the form of data and metadata modifying variables corresponding to physical properties of the physical system, the system being provided with at least one module connected to the devices, the module being provided with a memory and a processor to carry out the following steps: receiving data and metadata modifying variables, from the devices; detecting input pattern based on the data and metadata received by all the devices; dynamically generating a customized data structure based on the input pattern; updating the model data structure of the devices with the customized data structure.

The wording “physical system” is used here to depict a real-life system with physical properties such as dimensions, weight, electrical or thermal coefficients, etc. For example, the physical system can be an urban system constituted by buildings, roads, crossroads, etc. It can alternatively be an aeronautical system, a chemical system, etc.

The “variables” can characterize the physical system. Each variable is thus associated with a real-world concept of the physical system. Here is a non-exhaustive list of examples of the variables within the context of the invention: dimension (height, length, etc.), time, electrical current or voltage or power, GPS or cartesian coordinates (e.g., position of an object), thermal insulation coefficient, pressure, temperature, a number (e.g., number of floors for a building or number or buildings per street, etc.), a category (energy label), a ratio, a price, etc. For example, if the users face the problem of defining the size, position and orientation of a house on a pre-defined piece of land, the variables can be the dimensions of the house and its orientation.

The variables can have various types or format (integer, date, %, etc.), and be defined by a single value, one or more ranges of values (or a set of discrete values), a statistical distribution over a range, etc. (the term “range” is used for any set of values that can be, e.g., a singleton set or not, and/or, a connected set or not, and/or, a finite set or not, and/or a discrete set or not). They can be the result of computation based on other variables, or they can serve as basis for a computation of another variable.

In some circumstances, several variables can depict a common physical reality. For instance, if a building can have a height between 10 and 15 meters, or alternatively can be in the range 20-25 meters, two distinct variables can be allocated to the two distinct ranges.

The input device can be a tangible device. A Tangible User Interface, TUI, is defined as an interface which employs physical artefacts both as representations and controls for computational media, giving physical form to digital information. In such a case, the variables can mirror (optionally at scale) the position or configuration of the tangible artefacts (for instance tangible slider).

The variables can be grouped initially or during processing. A group of variables can reflect the electrical installations of a building. A sub-group can relate to the electrical supplies whereas another sub-group relates to the lights. Both sub-groups can impact the energy label of the building (another variable) together with the thermal insulation or the presence of photovoltaic panels on the roof. Groups or sub-groups of variables can form templates which can be activated when the system recognizes the type of complex-problem that is dealt with or according to the input pattern. A database containing the templates or parts of templates can be provided and the system uses these templates or parts of templates or indicates to the user which templates or parts of template to use, assemble or modify, depending on the detected input pattern.

The templates speed up the modelling of the problems and/or the selection of (groups of) solutions. For instance, in a context where the brightness of a room must be chosen, when the users work on the problem of the brightness of the lamps, the templates can extend the problem to the selection of shutters/window blinds and to their position (open/close).

During the processing of the resolution of the complex problem, some variables can be joined in a sub-group when they are modified simultaneously by different users. A given variable can belong to several sub-groups. A sub-group of variables and an associated set of values (which can change from step to steps or can be different depending on the sub-groups for the same variable) can define the working space of a particular user or group of users at a particular time during the process.

The “processing of the resolution” comprises both the various input given by the users as well as the computing made to help find solutions or new variables. When conflicting values appear for variables, the system can indicate that there is no possible solution to satisfy all constraints simultaneously. This can save time and processing power, similarly to a field of a form that only allows a specific format (e.g., date, integer, etc.), however in the context of a complex-problem solver, the determination of incompatible solution is harder to define than a simple format restriction.

If the system indicates that there is no possible solution, he can suggest one or more user to delete or modify the variables that he/she/they entered.

Variables can be created or deleted by the users, either in the model data structure or the customized data structure, or both.

The “data” input by a user can for instance relate to a modification of a variable, its creation, or deletion. The “metadata” comprises information related to the data, e.g., the way the user inputs the data, the name/ID of the user, a time-stamp or history of the modifications, the kind of data, etc.

The “model data structure” comprises variables, their associated values, and their relationships, constraints or targets to be optimised, user interface, mathematical or physical models that are involved in the context of the issue at stake. The targets can be optimal solution or sub-optimal solutions (Pareto trade-offs). The model is defined by the intersection of all variables associated to users; this can result in an empty set of value for some variables. The system can exclude some user and/or can lock all variables except those in conflict so that users are invited to modify those variables. The exclusion of a user can be performed by actively informing a user of his/her exclusion or by simply ignoring the inputs of this excluded user or adapting the graphic interface corresponding to the zone of action of this excluded user. The purpose being to reduce useless interactions (reducing required processing power) when knowing in advance that the interaction of one particular user creates a conflict in the variables rendering a solution impossible to find. Hence, the system detects sooner than later that the group of solution is empty, and the system acts accordingly.

The “customized data structure” is built from the detection of input patterns and it updates the model data structure. This is a clear distinction from any other system. In a regular computer interface, clicking on an icon or a function in a software can allow the user to set the parameters of the structure or the interface. In contrast, the system of the present invention detects an input pattern based on the inputs of the users (for example modifying a property of an object, such as the height of a building). The inputs of each user do not correspond to an instruction to alter the data structure: a user is normally not aware of the consequence that can have his actions on the structure (especially since the pattern is inherited from the actions of multiple users). The system can in particular assist the users by modifying the data structure in a way that the users would not have thought.

It is thus the interaction between the users and the objects that affects the structure, rather than the interaction between the users and the structure.

The model data structure can comprise properties regulating the working space, and the way the input patterns are dealt with. For instance, when two users modify a variable differently, the system can detect this as a pattern and have a particular behaviour according to predefined properties, such as: refuse both modifications of the variable; split the working space into two sub-spaces allowing each user to work out a solution; join the two users in a working space (by creating a sub-group of users and sub-group of variables); exclude one of the two users from the users entitled to act upon this particular variable. “Space” or “sub-space” is used to depict the set of variables on which a particular user can act. This is different from the physical space (around a tangible table for instance) which the user can access.

In the example above, the users' input is the modification of a parameter, without the intention or expectation to see the data structure modified. The system detects a pattern from the inputs and customizes the data structure based on this pattern.

Generally, an “input pattern” can be detected when more than one user interacts with a common variable or with variables which are interrelated with each other, consistently or inconsistently. Other pre-defined rules can be set to define any kind of pattern to be detected. For instance, a succession of actions from various users can be detected as a particular input pattern. The detection of an input pattern can be complex as the detection can be done dynamically upon simultaneous or sequential input of various users. The system can be adapted to use any kind of formal grammar (e.g., regular, context sensitive, tree-adjoining, graph, attributed, etc.), and one locutor can sometimes be several users acting together as a single input giver (team work, for instance, when four hands are necessary to represent a square on the input surface). This is particularly advantageous in a multi-user problem-solving environment.

The detection of pattern is not limited to the modification of variables. The data structure of a given device can be modified by the module even if the user has not acted on variables, if for instance other users have been modifying other variables which then result in the modification of data structures. Thus, the working sub-space presented to a user can be continuously modified in the aim of reaching quickly a solution to the complex problem. When the users are interacting with the customized structure, each user is facing a dedicated interface with particular limits to their actions, leading to a more efficient and faster solution. The time and energy consumed by the treatment or transit of all the data is reduced as well.

The pattern can be detected by mathematical inferences, automatic simulations, automatic analytics, automated machine learning, predetermined or dynamically evolving rules, etc.

In the sense of the present invention a “problem” can be considered as a set of variables, each variable having a set of allowed values, together with equations to be fulfilled with these variables. A “solution” is the combination of selected values (or ranges, as defined above) for each variable of the problem.

The invention as defined here above acts therefore on the user-computer interface by modifying the data structure accessible to the user, as a consequence of the users' inputs, reaching therefore a solution to the complex-problem and avoiding data transmission, data storage and computing power to be used, in comparison to a problem that would be solved without the assistance of the customization of the data structure as specified above. The automation of the customization by detection (i.e., not triggered by requests of the user) is particularly advantageous.

According to an exemplary embodiment of the invention, the detection of input patterns comprises the detection of modifications of common variables by a sub-group of users, and the generation of the customized data structure comprises the segregation of the variables of the model data structure into sub-groups of variables and the generation of a respective set of rules for each sub-group of variables or the selection of a respective set of rules for each sub-group of variables among pre-set rules, wherein the sub-group of users is given or refused the possibility to modify the variables of a sub-group of variables only according to the respective rules.

Over the entirety of variables of the structure, the system can thus detect that some users interact with part of the system, hence a sub-space of work, related to a sub-group of variables. The “common variables” can be the same variables of the system or can be variables interrelated through a pre-determined mathematical or physical relationship. For example, if a user is adjusting the height of a building and another user is modifying the number of storeys or the footprint, each of these variables can be common although they do not have the exact same physical significance. A sub-group of users (=one or more users) can then interact with a sub-group of variables. The various sub-groups of variables for the various sub-groups of users are distinct, overlapping, or identical. When the variables of several sub-groups are identical, the various sub-group of users can be granted different authorizations with respect to the possibility to modify the variables of the sub-group of variables: in other words, two sub-groups of users can have authorization to modify a common sub-group of variables, but one of the sub-groups of users will have more freedom to modify the variables than the other.

The possibility that is given or refused to modify some variables can not be binary and can entail various levels of authorizations or prioritizations. Some users can be given the possibility to freely modify a variable, whereas other users can only modify a value in a particular range, or position a tangible device in a particular position or configuration.

The possibility that is given or refused to modify some variables also comprises inherently a suggestion to the users, by providing of a default value displayed in a field or by a restriction of a particular range (as mentioned above, in this patent application, the term “range” is used for any set of values that can be, e.g., a singleton set or not, and/or, a connected set or not, and/or, a finite set or not, and/or a discrete set or not). Thus, the system can provide advices or enforce some restrictions. In other words, the system detects automatically that several users work on the same variables, creates the sub-groups and enforces group work.

The system thus creates working space for a particular set of variables and for a particular set of users with common or different authorizations to alter the variables. The working spaces can be displayed sequentially as tabs to reorganize the resolution of the problem after detection of input patterns.

The user interfaces can comprise natural user interfaces, tangible user devices (tangible tables), virtual or augmented reality interfaces, camera, or any kind of computer-user-interface.

The generation of the sets of rules comprises the selection or simple rules (IF . . . THEN . . . , compatibility rules between two related parameters, etc.) or the creation of a new rule instantiated upon detection of the input pattern.

The users can be informed of the rules in the working sub-space, so that the process of problem resolution is faster.

Further to the properties of the model data structure exposed above, the sub-groups of variables or sub-working space can contain: rules related to incompatibilities of variables of the sub-group, functional dependencies (or independence) amongst variables, symmetry of variables, local optimums.

All these variants help the computing system to prevent the users from evolving in a direction of a non-working solution as they are forbidden to formulate incompatible equations. The users thus reach a solution to the complex problem within a reduced amount of time and with reduced needs for computing resources.

Here again, the customized structure enabling or not the users to interact with variables is dictated by the detected pattern and not by the users themselves or their individual input.

The number of interactions between the user and the system is reduced, and the chances of mistakes made by the user is reduced. The automation with the rules enforces a flawless customization of the structure without incompatibilities between potentially conflicting intentions of the users.

According to an exemplary embodiment of the invention, the users or sub-groups of users are identified and the set of rules comprises user-specific or sub-group specific permissions to modify variables both in terms of which variables can be modified and in which way they can be modified. The permissions can evolve dynamically. For instance, if two users are permitted to change a variable, the first one to act in time can have more freedom to alter the variable than the second one. The automation through the rules improves here also the flawlessness and velocity of the resolution of the complex problem.

According to an exemplary embodiment of the invention, the sets of rules comprise the enforcement of values for one or more variables and/or restrictions on the possible values that a variable can take, such as format of the variable, value in a range or position or configuration of a tangible input device. Thus, the system automatically enforces values or restrictions based on the detected pattern. The system does not require any user interaction where a user would decide to restrict the freedom of other users. On the contrary, the system assists the users to help them progressing towards a quick solution to the complex-problem. The solution is thus obtained more efficiently without a user deciding to restrict the freedom to act of the other users.

According to an exemplary embodiment of the invention, the detection of an input pattern comprises the detection of sequential modifications of common variables by successive sub-groups of users and the generation of the customized data structure comprises the segregation of the variables of the model data structure into successive sub-groups of variables, wherein the successive sub-groups of users are given the possibility to modify the variables of a sub-group of variables in a sequential manner. This way, the system detects the intentions of the community of users (pattern) and decides autonomously on a sequence to be respected, resulting in a more efficient reach of the solution.

According to an exemplary embodiment of the invention, the detection of an input pattern comprises the detection of transitions between two sequential modifications of common variables by successive sub-groups of users, and the generation of the customized data structure comprises the generation of sub-groups of overlapping variables made of at least part of the variables of a sub-group of variables before the transition and at least part of the variables of a sub-group of variables after the transition, and wherein the sub-groups of users are given the possibility to modify the variables of the sub-groups of overlapping variables.

The possibility that is offered to users to modify variables and/or the prohibition from modifying variables is thus sequentialized by the system. In practice, after a short period during which the users can independently interact with the system, they are shortly directed to successive environments generated by the system to organize the resolution of the problem in a sequential way. The sequences can comprise if needed, iterations for defining some variables by progressive resolution.

In this way, the system can determine the restrictions to be applied to each variable in a sequential manner which is faster than computing the entire system with several independent sets of variables.

According to an exemplary embodiment of the invention, the detection of an input pattern comprises the detection of a plurality of different discrete values as input data for a given variable from one or more users, and/or the detection of a level of hesitation of a user, for instance through body language recognition, and/or similarly the detection of a consensus or of a level of quality of cooperation and/or the frequency of modification of a given variable, and the generation of the customized data structure comprises a feedforward to the users suggesting a range of values based on the discrete values and/or based on the level of hesitation or level of cooperation. The level of cooperation can be detected, for instance, through analysis of direct verbal communication, and/or indirect communication using body language (e.g., analysing posture, gesture, gaze, and facial expressions). Physically measurable metadata are used to complement the data input of the user.

The metadata, i.e., all information related to the data that is input by a user, can indeed reveal that a user is hesitating between several values (for instance, multiple use of the backspace key, body language detected by cameras and adapted software to assess a level of hesitation, series of non-coherent inputs, . . . ).

The system interprets these hesitations as the possibility for a given variable to be restricted to a wide range of values (e.g., the range is the smallest connected set including all values detected during the hesitation (with an optional margin above and below the connected set). The feedforward or enforcement of the value of the variable can thus be influenced by the level of hesitation of the users. If several users are hesitant on a given variable, then the system will know that this given variable can be restricted to a wide range of values. The system can further restrict the range once the (other) variables, determined without hesitation, are set.

Similarly to the level of hesitation, the level of the quality of the cooperation, consensus between users or conflict can also be detected through the gesture analysis, the speech & voice recognition (keywords like “I agree”, “OK”, . . . aggressive voice tone, prosody, lack of verbal interaction). Appropriate individual feedback can help enhance the cooperation. The frequency of modification of a variable by a user or by several users can also be taken into account.

The suggestion that is made by the system customizing the data structure based on these detected metadata improves the efficiency of the resolution of the problem. The system predicts and anticipates further variables to be potentially changed by the user, based on the detected pattern of inputs.

According to an exemplary embodiment of the invention, the detection of an input pattern comprises the detection of interactions between users and the determination of sub-groups of users, and the generation of the customized data structure comprises a feedforward to the user, such as one of: suggesting to split the complex-problem into sub-problems; suggesting to call specific solvers; suggesting a particular user to consider working or not on a particular variable, based on the metadata input by this particular user; suggesting particular users not working on particular variables to do so, and vice versa, based on an evaluated potential improvement of the formation of sub-groups; suggesting particular users to communicate directly together about particular variables; suggesting an alternative solution to the problem which minimizes the distance between the solutions given by various users; wherein the feedforward is based on at least one of: preselected strategies; the metadata input by the users; the detection of interactions and/or the composition of sub-groups; available analysing resources.

By “suggesting” is not only meant the fact of giving a hint to the users towards a solution but also sometimes “enforcing” an exploration towards a solution that would not have been thought of by the users. The working spaces that are presented to the user can therefore be subdivided into sub-spaces, or enlarged to a wider working space with additional variables. For instance, when exploring the variables related to a particular way of heating a building, the system can suggest to investigate another way of heating the building and hence pops up another working space with other variables. The system can lead a user towards a working space where he hasn't worked yet (or hasn't intended to work). The history of the interactions of a user can be recorded to that end.

The system customizes the data structure by instancing sub-spaces and presenting the corresponding and respective user interface to each user. The separation in sub-spaces can be considered as a subdivision of the model into sub-models that are enforced to the users.

In an exemplary embodiment, each or a sub-group of users have each a respective authorization (through biological recognition, password or tangible token) and the rules regulating the sub-spaces can be pre-set as a function of the respective authorization of the user (e.g., grouping users of similar authorization in a sub-space, or selecting one particular user with a given authorization per sub-space, or any in-between separation or grouping of users).

Thus, several users can work simultaneously on different sub-spaces constituted by several respective sets of variables to work out an optimum or sub-optimum (common) solution.

According to an exemplary embodiment of the invention, the devices comprise at least one of: smartphone, computer, display, tangible table, natural language and/or voice and/or speech recognition features, gesture, facial and/or emotion recognition features (speech, body language, voice, gestures, . . . ), or biomedical signal processing features.

According to an exemplary embodiment of the invention, the metadata comprise the grammar used by the users, such as the utterance or segmentation of speech or gesture, the number of user(s) interacting at once with the device or with each other, the lexicon, syntax or semantics.

Non-standard grammar can be used to enrich the communication between users and devices.

The system can identify compatible users having compatible (hence similar, or complementary) grammar.

According to an exemplary embodiment of the invention, the detection of the pattern comprises the detection of grammar used by one or more users, and the generation of the customized data structure comprises a suggestion to one user to alter its grammar. Grammars used by computers can be represented by a set of rules, or by other more complex formalisms. Patterns can be defined by pattern rules, such as regular expressions, or use a logic programming rules flavour, or other formalisms. Templates of user interaction are linked to templates of the complex-problems, and templates of grammars.

The system monitors and detects evolutions in the grammar used by the users.

The system can suggest to a user to change his/her role amongst the group of users and/or to alter its behaviour.

Hence, the system contains rules adapting the data structure based on evolution of grammars used by the users. Thus, the user interface changes the technical capacity of the user to provide an input. The customized data structure is thus adapted to the user and facilitates the exchanges between the user and the machine, thereby enabling a more efficient problem resolution.

According to an exemplary embodiment of the invention, the system is adapted to perform multiple iterations for solving a single complex problem or for solving multiple successive complex problems, and the system comprises a record of the multiple customized data structures generated at each iteration, wherein the detected pattern in one iteration is compared to the detected patterns of a previous iteration and the record is used to generate a customized data structure based at least partly on the data structure generated for similar patterns in a previous iteration.

During a particular process or during the series of iterations, the history of inputs (data and metadata), the history of the roles of each user, the history of the ID of the users, the history of the rules, the history of sub-groups of variables or users, and/or the history of the previous solutions to the problems can be taken into account for further iterations or for further problem solving. The system can thus learn and be fed from previous occurrences.

The system is also prevented from entering an endless loop and is prevented from reiterating previous potential dead-ends.

By using knowledge of previous attempts to solve a problem or previous solving process, the system is enriched and rendered more efficient.

After several iterations, the “customized data structure” can lead to very few updates to the model data structure, if any. The resulting convergent customized data structure can thus be used for solving complex problems when facing a future similar situation, thereby saving computing power, as well as storage and data transmission capacity.

The invention also relates to a computer-implemented method for solving a complex problem using a multi-user complex problems resolution system as in one of the above embodiments, wherein the devices are located in different rooms and/or are used by users of different level of expertise.

According to an exemplary embodiment, a given user is represented by an avatar which mirrors its gesture, gaze and/or facial expression on the device of another user.

In comparison to known systems which do not match a user with a particular space of interaction, the present invention allows a substantial improvement in the efficiency for solving complex problem as it detects a space on which a particular user can provide input, and it identifies dynamically groups or sub-groups of users who cooperate on a common space (without necessarily them being initially aware of acting on a common sub-space or without them being initially aware of the other users).

While “space” is used in the present patent application to define the set of variables on which a user can act, the present system can additionally detect the actual physical space of the user (around the tangible table, gesture detection, part of the display that is acted upon, etc.).

The groups or sub-groups of users are associated to groups or sub-groups of variables or equations or rules and/or are authorized to modify particular properties of the space and/or are authorized to provide input for particular steps in the resolution/modelling procedure (steps which can be created during the procedure itself).

With the assistance of the system of the invention, fewer experiments are required to confirm the solution that is found: in absence of a system dealing with multiple users' desires, several users can require to experiment their preferred solution whereas with the system of the invention, the responsiveness of the system is such that the non-optimal solutions are dismissed.

The system of the invention can also manage the various authorization to act or not on particular variable for each user, thus improving the robustness of the system and its reliability.

The system also prompts users with fields to be filled in, with the restriction to some particular values in coherence with input already made by all the users, thus saving time and resources.

Data related to solutions that are never entirely formed can be deleted, requiring less memory capacity. Dynamic computation, during the formulation of the solution by the users, avoids the total computation of every single solution (even the worse ones). Thus, the computing capacity needed is lessen.

Also, the sub-division of the complex problem into sub-groups of variables dealt with by sub-groups of users allow a better management of the microprocessors, in particular when a multi-core microprocessor can dedicate a core to a working sub-space.

### DRAWINGS

The invention will be described more in details in relation with the following figures:

FIG. 1 exemplarily illustrates an example of a system according to various embodiments of the invention;

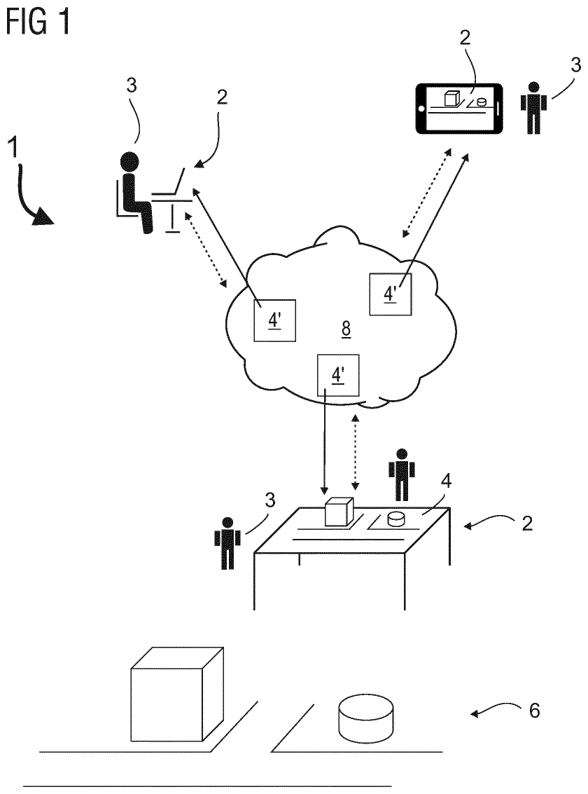

FIG. 2 exemplarily shows a flow chart of a method according to various embodiments of the invention.

### DETAILED DESCRIPTION

The following paragraphs describe an illustration of an application of the system according to the invention.

The system 1 comprises one or more device(s) 2, which can be any computing device, as for instance a smartphone, a wearable, a computer, a tangible table, etc. The devices 2 can have one or several of the features discussed above (gesture recognition, speech recognition, facial recognition, etc.). One or more users 3 can interact with a device 2 via an interface and according to a data structure 4. The devices 2 are each provided with means (software, hardware) representative of a real physical system 6. The devices 2 are connected to each other in a network via a module 8. The module 8 receives input from the devices and in particular data and metadata and in particular upon modification of variables in the data structure 4 of a device 2. The module 8 detects input patterns based on the data and metadata received from several devices 2, creates individualized customized data structures 4′ for each respective device 2 based on the input patterns, and updates the data structure 4 of the devices 2 according to the customized data structures.

Several users 3 can be gathered around a tangible table 2 and/or can act on a computer device 2. They cannot have knowledge of the issues at stake, or of any of the relationships between the variables that they are about to adjust and the results that they are seeking.

As an illustrative embodiment, the system can aim at solving an urban complex problem. For instance, the users 3 can be dozens of citizens or municipality policy makers required to design a district for 200 families. They can choose all the variables such as houses or higher buildings with different sizes of floors. They need to optimize a few resulting factors, such as for instance the area on the ground that is occupied by the houses, or the overall cost of the utility supply (water, electricity, waste management, etc.).

Each person can have his/her opinion or interest on how to design the district and testing and experimenting all single solutions would be time and resources consuming. Looking for a trade-off after all the solutions have been materialized would also require a lot of time and resources. Thus, the system according to the invention dynamically assists the search for a solution, hence guiding the users towards a trade-off or an optimum solution more efficiently.

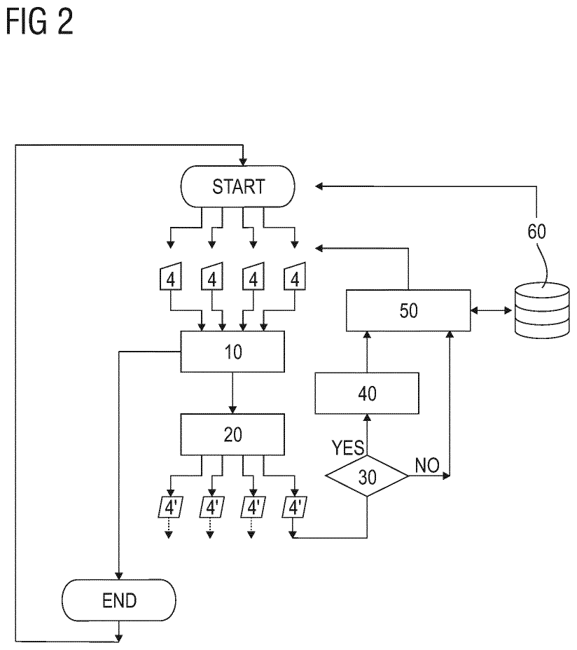

FIG. 2 illustrates schematically the method of the invention. The various users are presented with a data structure 4 on their device 2. They can start taking decisions, modifying variables. Based on the data and/or metadata related to the variables, the module 8 detects input patterns (step 10). Based on the input patterns and pre-defined and/or dynamically evolving rules, the module generates at step 20 a customized data structure 4′ for the respective devices 2. The customized data structures 4′ can be such that dedicated working spaces are created for sub-groups of users able to act on sub-groups of variables.

At step 30 is tested, for each device, whether the customized data structure 4′ of a particular device 2 is different from the pending data structure 4. If yes, then the data structure is modified (step 40) for the given device 2. At step 50, the module 8 interacts with a record of the data structures 60. The record 60 allows the potentially modified data structure to be recorded, and/or the modified data structure to be fed with previously recorded data structure to optimise the new data structure 4 for a given device 2. The record 60 can also be used to feed the initial model at the start of a process. The record can take any form most appropriate to the data structure used (database, list, log protocol, etc.).

Then, the cycle starts again. It has to be noted that although the method is represented as a sequence of steps, the steps are carried out continuously for each modification of a variable in a device 2.

When no modification is made anymore to the variables and/or when a converging solution is found or several sub-optimal solutions are found, the module 8 detects a corresponding common input pattern that leads to the end of the method, thus potentially before the resolution of the complex problem.

The method can be repeated several times to solve the overall complex problem at different scales. For instance, in the example given above, it can be decided in a first instance of the method that a 20-story building is to be built, rather than 20 single-family houses. In a second instance of the method, the various technical details (orientation, position, etc.) of the 20-story building are decided.

The successive instances of the method can make use of the record of data structures 60. The previous instances can thus feed the successive instances to enrich the system so that it enables the users to find a solution to the complex problem even faster.

The system of the invention can also sub-divide (when creating sub-groups of users when updating data structures) the users into a group investigating the solution of 20 family-houses and a group investigating the 20-story building. The two investigations can continuously be compared until one can eventually be abandoned.

The simultaneous and continuous monitoring of the variables on each device enables a direct and more efficient communication between the users. One user who can not think of a particular idea will quickly pick up a scenario without any other user being frustrated that his ideas are rejected.

The module 8 manages the roles, authorizations, priorities of interactions of all users, and provides suggestions or restrict the values of some variables as explained above.

The data structure 4 can also manage the way the information is displayed on the device so that variables that a user 3 is expected to validate or modify pops up in front of his gaze and/or with various adapted form, whereas variables which are fixedly defined or for which the user 3 has a lesser priority to decide upon, are hidden or shown less prominently on the display.

Thus, the display on a given device 2 is at least partly impacted by the inputs given on variables by other users. The system thus helps the users towards a solution that can be found more quickly than if all users are free to enact on every single variable at any time. The required resources in memory are lessen because a smaller amount of data is to be transferred and dealt with at a particular instant.

The feedforward or suggestions given to a user can be of any nature: visual (light on a tangible table, LED, external lamp, beamer, etc.); audio (audio source, external speakers); haptic (vibrations on the device or on a connected wearable, etc.).

To further enhance the cooperation between remote users, avatars can be used to efficiently represent the emotions, the gesture behaviour or any other information of a remote user that is perceptible by its device.

In another illustrative example, a user can modify the size of the window of a building during the complex-problem solving process. By doing so, the system detects that variables in relation to the size of the window is modified and hence suggests to the user to work on the orientation of the building, as the size of the window is connected to the luminosity in the house and to the heating (e.g., a bigger window on the South wall reduces heating needs). Hence, from the window's size modification by the user, the system detects that the user can want to work on the luminosity and/or heating.

The system can then also detect other users' inputs in relation to luminosity and/or heating and create a subspace with a subgroup of users to work on these issues. The system will then indicate to the users that several of them are working on the same issue and can prevent incompatible solutions to be worked-out. Time is saved by not investigating dead-end paths.

1-13. (canceled)

14. An urban design multi-user complex problems resolution system, said system comprising:
a plurality of interconnected user devices, each of the user devices embedding a model data structure comprising a representation of a physical system, the physical system being common for all user devices, and each of the user devices being configured to receive input from one or more users in the form of data and metadata modifying variables corresponding to physical properties of the physical system; and
at least one module connected to the devices, the module being provided with a memory and a processor to carry out the following steps:
receiving data and metadata modifying variables, from all the devices;
detecting an input pattern based on the data and metadata received from all the devices;
dynamically generating a customized data structure based on the input pattern; and
updating the model data structure of the devices with the customized data structure.

15. The system according to claim 14, wherein:
detecting an input pattern comprises detecting modifications of common variables by a sub-group of users, and
dynamically generating the customized data structure comprises:
segregating the variables of the model data structure into sub-groups of variables; and
generating a respective set of rules for each sub-group of variables or selecting a respective set of rules for each sub-group of variables among pre-set rules,
wherein the module is further configured to allow the sub-group of users to modify the variables of a sub-group of variables only according to the respective rules.

16. The system according to claim 15, wherein the users or sub-groups of users are identified and the set of rules comprises user-specific or sub-group specific permissions to modify variables both in terms of which variables can be modified and in which way they can be modified.

17. The system according to claim 15, wherein the sets of rules comprise the enforcement of a restriction comprising a format or a range of values for a given variable of the variables, or a restriction of a position of a tangible input device.

18. The system according to claim 14, wherein:
detecting an input pattern comprises
detecting sequential modifications of common variables by successive sub-groups of users and
generating the customized data structure comprises:
segregating the variables of the model data structure into successive sub-groups of variables,
wherein the module is further configured to allow the successive sub-groups of users to modify the variables of a sub-group of variables in a sequential manner, and
wherein detecting an input pattern comprises:
detecting transitions between two sequential modifications of common variables by successive sub-groups of users, and
generating the customized data structure comprises:
generating sub-groups of overlapping variables made of at least part of the variables of a sub-group of variables before the transition and at least part of the variables of a sub-group of variables after the transition, and wherein the module is further configured to allow the sub-groups of users to modify the variables of the sub-groups of overlapping variables.

19. The system according to claim 14, wherein:
detecting an input pattern comprises
detecting a plurality of different discrete values as input data for a given variable from one or more users, and/or
detecting the frequency of modification of a given variable, and
generating the customized data structure comprises providing a feedforward to the users suggesting a range of values based on the discrete values and/or based on an estimated level of hesitation of the users.

20. The system according to claim 14, wherein detecting an input pattern comprises detecting interactions between users and determining sub-groups of interacting users, and
generating the customized data structure comprises providing a feedforward to the users, the feedforward comprising at least one of:
suggesting to split the complex-problem into sub-problems;
suggesting to call specific solvers;
suggesting a given user to consider working or not working on a particular variable, based on the metadata input by this given user;
suggesting particular users not working on particular variables to do so, and vice versa, based on an evaluated potential improvement of the formation of sub-groups;
suggesting given users to communicate directly together about particular variables; and
suggesting an alternative solution to the problem which minimizes the distance between the solutions given by various users;
wherein the feedforward is based on at least one of:
preselected strategies;
the metadata input by the users;
the detection of interactions and/or the composition of sub-groups; and
available analysing resources.

21. The system according to claim 14, wherein the user devices are at least one of: a smartphone; a computer; a display; a tangible table; and wherein the user devices comprise at least one of: a natural language feature; a voice or speech recognition feature; a gesture recognition feature; a feeling or an emotion recognition feature; facial recognition features or biomedical signal processing features.

22. The system according to claim 20, wherein the metadata comprise at least one of: the grammar used by the users such as the utterance or segmentation of speech or gesture; the number of users interacting at once with a given user device or with each other; the lexicon; syntax or semantics.

23. The system according to claim 22, wherein detecting a pattern comprises detecting grammar used by one or more users, and generating the customized data structure comprises suggesting to one user to alter their grammar.

24. The system according to claim 14, wherein the system is adapted to perform multiple iterations for solving a single complex problem or for solving multiple successive complex problems, and the system comprises a record of the multiple customized data structures generated at each iteration, wherein the detected pattern in one iteration is compared with detected patterns of previous iterations and the record is used to generate a customized data structure based at least partly on the data structure which had been generated for a similar pattern in a previous iteration.

25. A computer-implemented method for solving an urban design multi-user complex problem, the method using an urban design multi-user complex problem resolution system comprising:
a plurality of interconnected user devices, each of the user devices embedding a model data structure comprising a representation of a physical system, each device being configured to receive input from one or more users in the form of data and metadata modifying variables corresponding to physical properties of the physical system,
at least one module connected to the devices, the module being provided with a memory and a processor, said method comprising the following steps:
receiving data and metadata modifying variables, from all the devices;
detecting an input pattern based on the data and metadata received from all the devices;
dynamically generating a customized data structure based on the input pattern; and
updating the model data structure of the devices with the customized data structure,
wherein the devices are located in different rooms or are used by users of different level of expertise.

26. The method according to claim 25, wherein the module is configured to represent a given user with an avatar on the user devices, the avatar mirroring the gesture, gaze and facial expression of the given user.
